(19) United States
(12) Patent Application Publication
(10) Pub. No.: US 2022/0078966 A1
(43) Pub. Date: Mar. 17, 2022

(54) LINEAR ACTUATOR FOR DOWN-FORCE AND LIFT ON PLANTER CLOSING SYSTEM

(71) Applicant: SCHAFFERT MANUFACTURING COMPANY, INC., Indianola, NE (US)

(72) Inventors: Kris Schaffert, Indianola, NE (US); Jerry Graham, Sterling, CO (US)

(21) Appl. No.: 17/474,824

(22) Filed: Sep. 14, 2021

Related U.S. Application Data
(60) Provisional application No. 63/078,321, filed on Sep. 14, 2020.

(51) Int. Cl. A01C 5/06

(52) U.S. Cl. CPC A01C 5/066; A01C 5/064

(57) ABSTRACT

A furrow closing assembly includes a mounting bracket attachable to a planter opener frame, a rigid closer frame, and a four bar parallel linkage connecting the mounting bracket and the closer frame with a first pivot bearing and a third pivot bearing on the mounting bracket and a second pivot bearing and a fourth pivot on the closer frame. A screw-driven linear actuator extends between the parallel linkage to the closer frame. A shaft of the linear actuator is pivotably attached to a torsion axle that is further fixed to an upper portion of the parallel linkage. A load cell is positioned between the linear actuator and the closer frame.

### CROSS-REFERENCE TO RELATED APPLICATIONS

This application claims priority to and the benefit of U.S. Provisional Patent Application No. 63/078,321 filed Sep. 14, 2020 entitled “Linear actuator for down-force and lift on planter closing system”, the entire disclosures of which is incorporated herein in its entirety by reference.

### FIELD

The disclosed technology relates to agricultural seed planters and, in particular, to furrow closing systems.

### BACKGROUND

Agricultural seed planting is typically accomplished by multi-row planters. Each planter may include multiple row units adapted for opening a seed furrow, depositing seeds within the furrow, and closing the seed furrow around the seeds.

Some planters are equipped or retrofitted to be equipped with fertilizer depositing equipment (e.g., fertilizer furrow opener discs and fertilizer deposit tubes) located on a leading or front side of the planter. Planters so configured can have problems in fields with moist or wet soil. Specifically, disturbing the soil with the fertilizer equipment located in front of the planter gauge wheels can cause the moist or wet soil to accumulate on the gauge wheels. The soil accumulation increases the effective diameters of the gauge wheels and causes the planter to run too shallow with respect to the depositing of the seed in the seed furrows.

Planters are increasingly used in no-till situations, resulting in the planter traversing fields with substantial deviation in the field surface and a substantial amount of obstructions (e.g., debris, clods, stubble, old furrows, etc.). Furthermore, in certain Midwest farm areas, ditches must be plowed in fields between planting seasons to facilitate the drainage of spring showers from the fields. Most planters have proven ineffective in such rough field surface conditions. It is not unusual for the use of planters in rough field conditions to result in seed depths that radically range between too deep and too shallow. Also, it is not unusual for the use of planters in such field conditions to result in the planter components being damaged.

Traditional closing assemblies use standard swing arm tail sections, which can be found on many of the planters built today. But, these swing arm tail sections have a limited amount of travel up and down (roughly 4″) throughout full movement when planting. These tail sections are limited when there are ditches to cross or terraces to plant over, as the amount of travel is limited to 2″ both ways of center. Sometimes this isn't enough as it gives poor seed to soil contact by not closing the seed V properly or leaving seeds on top of the ground. Whenever the press wheels flex up the contact points on the press wheels get wider causing them to be toe out and they tend to over cover the width of the seed V. When the press wheels go down past center they under cover resulting in toe in, which causes the seed V to not close properly. Also when the wheels max out, the wheels on the top side can raise the planter unit out of the ground causing seed depth to change. By running extra spring pressure on the press wheels you create up pressure on the row units. Thus, swing arm tail sections have severe limitations.

Furthermore, as the planter travels through the field at speeds above 5 MPH, the swing arm closing systems are constantly moving or vibrating up and down along the planter unit itself causing uneven depth control. Also when planting up and over terraces, there are areas over the top of the terrace that cause the double discs of the planter to lift out of the ground, thereby planting the seeds on top of the ground. In some instances the press wheels to carry the weight of whole planter on one side or other of the terrace, and then on the opposite side of the terrace, the double discs openers bottom out for depth and the press wheels are lifted off the ground and are unable to close the furrow. This leaves several feet of seeded area across a ditch or terrace that is blanked out due to poor seed to soil contact.

A press wheel or firmer wheel is a wheel attachment on an agricultural unit for compacting the soil in the seeded furrows after the soil has been planted and, in some instances, after a closing wheel has deposited loose soil overtop of the seed. Traditional press wheels compress and mold the bottom of the furrow to establish an environment conducive to good germination. Seed germination is promoted through soil compaction by minimizing air pockets, thus improving the capillary action of the moisture in the soil as well as reducing wind erosion of the soil over the seed.

The information included in this Background section of the specification, including any references cited herein and any description or discussion thereof, is included for technical reference purposes only and is not to be regarded subject matter by which the scope of the invention as defined in the claims is to be bound.

### SUMMARY

A typical agriculture planter may include a planter frame, a seed hopper, and a trailing arm assembly. The planter frame may include a hitch tongue extending forward from the planter frame for attachment to a tractor that pulls the planter. The trailing arm assembly may be coupled to a rear portion of the planter frame via a parallel linkage and extend rearward from the planter frame, and include separate, but adjustable, trailing arm assemblies for the opening implements and the closing implements.

A furrow closing assembly for the agricultural planter may include a mounting bracket configured for attachment to a furrow opener assembly of the agricultural planter. A rigid frame forming part of the furrow closing assembly may be configured for mounting furrow closing components thereon. A parallel linkage pivotably connects the mounting bracket to the rigid frame with a first pivot bearing connecting the mounting bracket to the parallel linkage and a second pivot bearing connecting the parallel linkage to the rigid frame. A screw-driven linear actuator may be fixed at a first end to the rigid frame and attached at a second end to the parallel linkage.

In any embodiment, the furrow closing assembly may include a torsion axle fixed to the parallel linkage. A shaft of the screw-driven linear actuator may be pivotably attached to the torsion axle. In an exemplary implementation, the torsion axle may be formed by extending an elongated block or tube of square cross section between and fixedly attaching it at each end to opposite bars of the parallel linkage. A square tube of larger perimeter dimension than the elongated block or tube may be placed concentrically about the elongated block or tube. A plurality of dense elastomeric members may be positioned between exterior walls of the elongated block or tube and interior walls of the square tube.

Also, in any embodiment, a load cell may be mounted between a first end of the linear actuator and the rigid frame.

In another implementation, a method of operating a furrow closer assembly having a parallel linkage attached between a furrow opener assembly and a frame of the furrow closer assembly and a screw-drive linear actuator fixedly mounted to the frame and pivotably mounted to the parallel linkage may include the following steps. The linear actuator may be actuated to extend a shaft of the linear actuator. A downward force is provided on the furrow closer assembly by extension of the shaft.

In another implementation, a furrow closing assembly for an agricultural planter is disclosed. The furrow closing assembly includes a mounting bracket configured for attachment to a furrow opener assembly of the agricultural planter. The furrow closing assembly further includes a rigid frame configured for mounting furrow closing components thereon. A furrow closing assembly further includes a parallel linkage pivotably connecting the mounting bracket to the rigid frame with a first pivot bearing connecting the mounting bracket to the parallel linkage and a second pivot bearing connecting the parallel linkage to the rigid frame. The furrow closing assembly further includes a torsion axle fixed to the parallel linkage. The furrow closing assembly further includes an actuator fixed at a first end to the rigid frame and pivotally attached to the torsion axle.

In another implementation, the torsion axle may be configured to allow travel between the actuator and the parallel linkage. The travel may be constrained by a plurality of torsion bumpers integrated with the torsion axle. The plurality of torsion bumpers may include a plurality of dense elastomeric members configured to compress with movement of the actuator relative to the parallel linkage.

In another implementation, the torsion axle may further include a torsion block fixedly attached to the parallel linkage. The plurality of torsion bumpers may be arranged about the torsion block. The torsion axle may further include a case wrapped around the plurality of torsion bumpers and the torsion block. In this regard, the torsion block may further include a coupled plate extending from the case. The actuator may be pivotally attached to the torsion axle at the coupler plate. In some cases, a shaft of the actuator may be engaged in double shear with the coupler plate.

In another implementation, the actuator includes a screw-driven linear actuator. The screw-drive linear actuator may include an electromechanical device with a screw drive. The screw-drive linear actuator may be configured to provide static resistance to external forces received by the parallel linkage.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. A more extensive presentation of features, details, utilities, and advantages of the present invention as defined in the claims is provided in the following written description of various embodiments and implementations and illustrated in the accompanying drawings.

### BRIEF DESCRIPTION OF THE DRAWINGS

The disclosure will be readily understood by the following detailed description in conjunction with the accompanying drawings, wherein like reference numerals designate like structural elements.

FIG. 1 is a side elevation view of an agriculture tractor pulling an agriculture planter.

FIG. 2 is a top-rear isometric view of the planter.

FIG. 3 is a top-rear isometric view of a prior art trailing arm assembly forming part of the planter.

FIG. 4 is a side elevation view of the trailing arm assembly of FIG. 3.

FIG. 5A is a top, side, perspective view of an embodiment of a furrow closer assembly with a four bar linkage connected to a linear actuator in a fully lifted position.

FIG. 5B is a top, side, perspective view of a furrow closer assembly with a four bar linkage connected to a linear actuator in a fully extended position.

FIG. 6A is a side elevation view of an embedment of a four bar linkage with a linear actuator mounted thereon for incorporation in to a trailing arm assembly.

FIG. 6B is a bottom side perspective view of the four bar linkage with the linear actuator of FIG. 6A.

FIG. 6C is top, rear, perspective view of the four bar linkage with the linear actuator of FIG. 6A.

FIG. 6D is rear perspective view of the four bar linkage with the linear actuator of FIG. 6A.

FIG. 6E is a partial rear, side, perspective view of the four bar linkage with the linear actuator of FIG. 6A detailing a torsion axle mounted to the four bar linkage.

FIG. 7A is a top, front, perspective view of a torsion axle mounted to another embodiment of a four bar linkage of a furrow closer assembly.

FIG. 7B is a top, rear, perspective view of the torsion axle of FIG. 7A.

FIG. 7C is a top, side, perspective view of the torsion axle of FIG. 7A.

FIG. 8 is a schematic, cross-section view of an embodiment of a torsion axle for connection to a linear actuator in any embodiment of a four bar linkage of a furrow closer assembly.

FIG. 9 is a cross-section view of the torsion axle of FIG. 6C, taken along line I-I of FIG. 6C.

FIG. 10A is a cross-section view of the torsion axle of FIG. 6C in a first configuration, taken along line II-II of FIG. 6C.

FIG. 10B is a cross-section view of the torsion axle of FIG. 6C in a second configuration, taken along line II-II of FIG. 6C.

The use of cross-hatching or shading in the accompanying figures is generally provided to clarify the boundaries between adjacent elements, e.g., when shown in cross section, and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

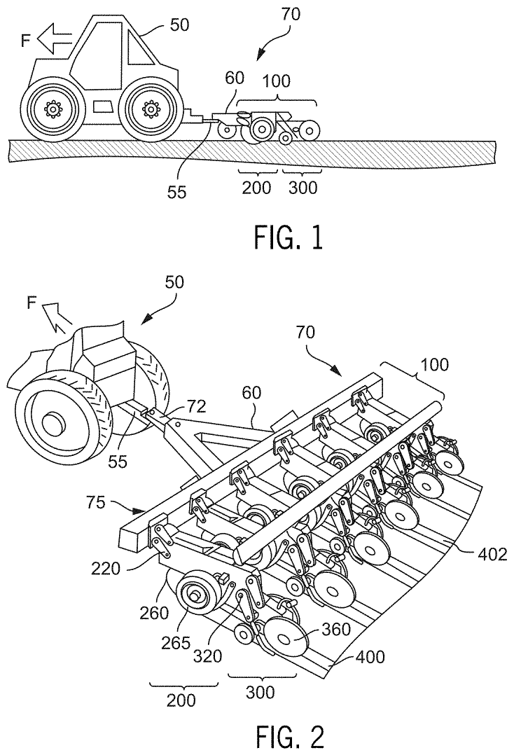

An exemplary embodiment of an agriculture planter 70 having one or more trailing arm assemblies 100 attached to an agricultural tractor 50 is shown in FIGS. 1 and 2. The agricultural tractor 50 may have a hitch receiver 55 extending rearward therefrom. As illustrated in FIG. 2, the planter 70 may include a planter frame 75 from which a yoke 60 with a tongue or hitch 72 extends in a forward direction. The hitch 72 connects with the hitch receiver 55 to couple the planter 70 to the tractor 50. Various planter components are supported on the planter frame 75 and extend therefrom in a rearward direction. The tractor 50 tows the planter 70 in the direction of arrow F and provides power to the planter 70 (e.g., via a power take off (“PTO”), not shown) for powering the operations of the planter 70. Additional operations of the planter 70 may be powered by hydraulics or electrical motors (not shown) powered by the tractor 50.

Components of the planter 70 may include a plurality of trailing arm assemblies 100. The trailing arm assemblies 100 may function as row units for planting seeds and distributing liquid fertilizer. Each trailing arm assembly 100 may have a planter frame 60 or yoke that extends from the front of the trailing arm assembly 100. Each trailing arm assembly 100 may be equipped with a furrow opener assembly 200. Each trailing arm assembly 100 may also be equipped with a trailing furrow closer assembly 300.

In the exemplary embodiment shown, the furrow opener assembly 200 may be connected to the planter frame 60 via a parallel linkage 220, such as a four bar parallel linkage. The parallel linkage 220 allow the furrow opener assembly 200 and the furrow closer assembly 300 to move vertically to follow the terrain (e.g., contours of the field), overcome obstacles (e.g., debris or the like), or otherwise negotiate similar changes in a surface 400 of a field. The furrow opener assembly 200 may include a guide wheel 265 and an opener disc 260. The furrow closer assembly 300 may include one or more closer wheels 360. In some embodiments, the furrow closer assembly 300 may further include a separate fertilizer opener wheel and a fertilizer dispenser (not shown). The vertical movement provided by the four bar linkage allows the trailing arm assemblies 100 to follow or translate up and down as the opener discs 260 and closer wheels 360 negotiate over or through an obstruction in a field surface 400 without adversely impacting seed deposit depth or resulting in damage to the components of the agricultural planter 70.

Because the trailing arm assemblies 100 are able to adjust to the contours of and variances in the field surface 400 through vertical translation via the parallel linkage 220, the opener discs 260 may be in consistent contact with the field surface 400, which may improve opening of furrows 402. Similarly, the trailing furrow closer wheels 360 may be in consistent contact with the field surface 400, which improves closing of the seed and fertilizer furrows 402.

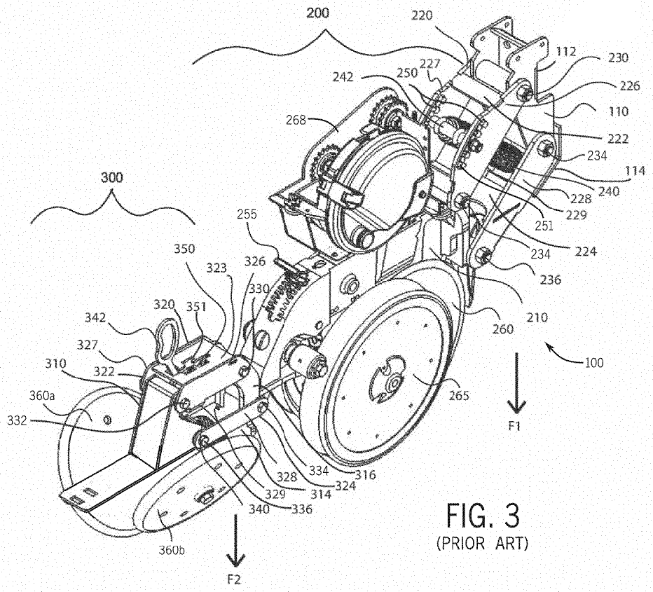

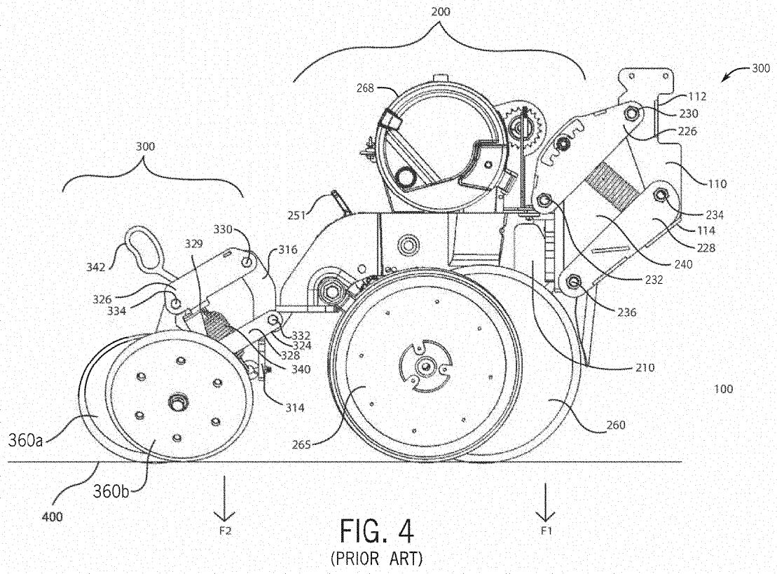

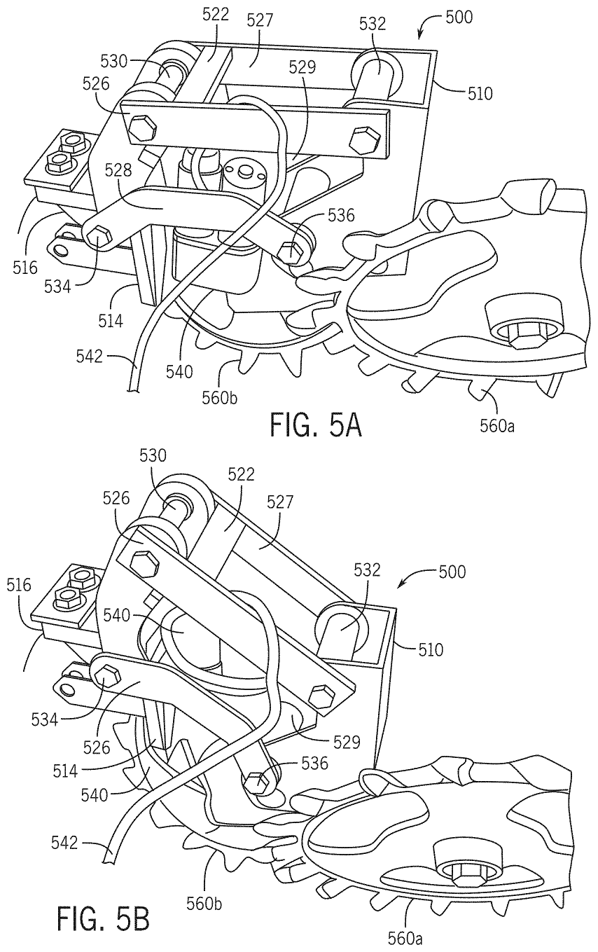

Exemplary embodiments of a typical trailing arm assembly 100 are depicted in FIGS. 3 and 4. FIGS. 3 and 4 are prior art depictions of the trailing arm assembly 100 with a furrow opener assembly 200 and a furrow closer assembly 300. This embodiment is shown and described for reference purposes for comparison to and orientation of the new parallel linkage system of the furrow closer assembly disclosed herein below and shown in accompanying FIGS. 5-10B. The furrow opener assembly 200 in the trailing arm assembly 100 may include an opener frame 210. One or more furrow opener discs 260, a gauge wheel 265, a seed hopper 268, and a fertilizer reservoir (not shown) may be attached to the opener frame 210. Each seed furrow opener disc 260 creates a furrow in which the planter 70 deposits seed in a manner well known in the art. The gauge wheel 265 assists in determining the depth at which the planter opener assembly 200 deposits the seed. The gauge wheel 265 is mounted to the frame 210 via a gauge wheel lever arm, which is pivotally coupled to the frame 210.

The furrow opener assembly 200 may be coupled to the planter frame 75 via a connection that allows the trailing arm assembly 100 to move relative to the frame 75. In any of the embodiments contemplated herein, the connection may be configured to maintain an approximately constant relative orientation between the furrow opener assembly 200 and the frame 75 through the range of motion of the trailing arm assembly 100. Any mechanical connection operable to maintain this relationship may be used. For example, the furrow opener assembly 200 may connect to the frame 75 via a parallel linkage 220. In any of the embodiments disclosed herein, the parallel linkage 220 may be a four bar parallel linkage. While a four bar parallel linkage 220 is shown in the figures, other connection mechanisms may be used as well. In other implementations, which may be used in any embodiment, a slide mechanism or a rail mechanism may connect the furrow opener assembly 200 of the trailing arm assembly 100 to the frame 75.

In any of the embodiments disclosed herein, the furrow closer assembly 300 may include a closer frame 310. The closer frame 310 may be connected to one or more furrow closer discs 360 or wheels, fertilizer opener discs, fertilizer injectors, or similar planter implements. Each furrow closer disc 360 closes a furrow over a deposited seed in a manner well known in the art. Any type of closer discs 360 may be used including flat discs, discs with tamping appendages, tires, and “Mohawk”-style discs, as well as others.

The furrow closer assembly 300 may be coupled to the opener frame 210 via a connection that allows the furrow closer assembly 300 to move relative to the opener frame 210. In any of the embodiments described herein, the connection may be configured the connection may be configured to maintain an approximately constant relative orientation between the furrow closer assembly 300 and the opener frame 210 through the range of motion of the furrow closer assembly 300. Any mechanical connection operable to maintain this relationship may be used. For example, the furrow closer assembly 300 may connect to the opener frame 210 via a parallel linkage 320. In any of the embodiments contemplated herein, the parallel linkage 320 may be a four bar parallel linkage. While a four bar parallel linkage is shown in the figures connecting the furrow closer assembly 300 to the opener frame 210, other connection mechanisms may be used as well. For example, a slide mechanism or a rail mechanism may be used in alternate embodiments.

The parallel linkages 220 coupled between each furrow opener assembly 200 and the planter frame 75 may have a first opener linking bar 226 and a second opener linking bar 228 arranged parallel to the first opener linking bar 226. The first opener linking bar 226 may be pivotably connected at a first end on a first opener pivot bearing 230 to a frame bracket 110 that is rigidly fixed (either permanently or removably) to the planter frame 75. The first opener linking bar 226 may be pivotably connected at a second end on a second opener pivot bearing 232 to the opener frame 210 of the furrow opener assembly 200. In this arrangement, the first opener linking bar 226 allows movement between the first frame 210 and the frame bracket 110. The second opener linking bar 228 may be pivotably connected at a first end on a third opener pivot bearing 234 to the frame bracket 110 that is rigidly fixed to the planter frame 75. The second opener linking bar 226 may be pivotably connected at a second end on a fourth opener pivot bearing 236 to the opener frame 210 of the furrow opener assembly 200.

The first opener linking bar 226 and the second opener linking bar 228 may be positioned in parallel relative to one another such that planes passing through the first and second opener pivot bearings 230, 232 and the third and fourth opener pivot bearings 234, 236, respectively, are parallel to one another. In this relationship, as the first opener linking bar 226 and the second opener linking bar 228 articulate through their range of motion, they remain parallel to one another.

In any embodiment, for example, as shown in FIG. 3, the parallel linkage 220 may also include a third opener linking bar 227 and a fourth opener linking bar 229 that are spaced apart from the first opener linking bar 226 and the second opener linking bar 228, respectively, and are positioned as mirror opposites thereof. The third opener linking bar 227 and the fourth opener linking bar 229 may be attached to the frame bracket 110 at first ends and to the opener frame 210 at second ends on pivot bearings located on the same axes as the pivot axes of the first, second, third, and fourth opener pivot bearings 230, 232, 234, 236, respectively. In any embodiment, the first and second opener pivot bearings 230, 232 may be shafts supported by the frame bracket 110 or the opener frame 210 to extend between and support both the first opener linking bar 226 and the third opener linking bar 227. Similarly, in any embodiment, the third and fourth opener pivot bearings 234, 236 may be shafts supported by the frame bracket 110 or the opener frame 210 to extend between and support both the second opener linking bar 228 and the fourth opener linking bar 229.

In any contemplated implementation, the first opener linking bar 226 and the third opener linking bar 227 of the parallel linkage 220 may be rigidly connected, for example, welded together with a cross-brace 222 to form a unitary structure. Similarly, the second opener linking bar 228 and the fourth opener linking bar 229 may be rigidly connected, for example, welded together with a cross-brace 224 to form a unitary structure. Such unitary formation may increase the lateral rigidity of the parallel linkage 220. The unitary formation of either or both the upper and lower opener linking bars 226, 227, 228, 229 may be accomplished by means other than cross bracing. For example, each pair of linking bars may be cast, molded, machined, stamped, welded, or formed together by any other method as a single piece. In any embodiment, the frame bracket 110 may have an engagement portion 112 that is fixedly attachable or removably attachable to a planter towing frame 75. The engagement portion 112 may provide stability proximal to the sides of the linkage 220 such that twisting of the trailing arm assembly 100 is minimized.

In the embodiment of FIGS. 3 and 4, the frame bracket 110 of the furrow opener assembly 200 may also include a mounting plate 114 positioned adjacent to or below the third opener pivot bearing 234 and adjacent to or between the second opener linking bar 228 and the fourth opener linking bar 229. As shown in FIGS. 3 and 4, the mounting plate 114 may be below the third opener pivot bearing 234 and also extend or bend under the second opener linking bar 228 and the fourth opener linking bar 229. By extending outward and under the second opener linking bar 228 and the fourth opener linking bar 229, the mounting plate 114 may be positioned to stop the parallel linkage 220 from allowing rotation beyond a certain point. For example, the mounting plate 114 may limit the second opener linking bar 228 and the fourth opener linking bar 229 from extending beyond 10-80 degrees off of the horizontal plane by being positioned to contact the second opener linking bar 228 and the fourth opener linking bar 229 at an angular orientation between 20-70 degrees off horizontal. In other examples, the angle of the mounting plate 114 may be between 20-70 degrees or more particularly between 30-60 degrees. In one example, the angle of the mounting plate 114 may be approximately 35 degrees with respect to the horizontal.

It is desirable that the trailing arms 100 provide a relatively constant downward pressure. Such a constant and consistent downward pressure allows for continuous opening and closing of furrows 402 and provides a consistent seed depth, preventing seed deposition from being too shallow or too deep, each of which negatively impacts germination. In the embodiment of FIGS. 3 and 4, a biasing member 240 is mounted between the parallel linkage 220 and the planter frame 75. In various known embodiments, the biasing member can be a tension spring, a torsion spring positioned around the third opener pivot bearing 234, or a hydraulic or pneumatic cylinder operable to extend or contract. In the embodiment shown, the biasing member 240 is a heavy gauge tension spring that is connected at a first end to the first opener linking bar 226 and the third opener linking bar 227 of the parallel linkage 220 and at a second end to the mounting plate 114. In this manner, the second end of the biasing member 240 has little or no movement relative to the planter frame 75. In some embodiments, the first end of the biasing member 240 may be connected to the cross brace 222 extending between the first opener linking bar 226 and the third opener linking bar 227 forming a unitary upper bar of the parallel linkage 220. In other embodiments, as shown in FIGS. 3 and 4, the first end of the biasing member 240 may be connected to a separate anchor bar 242 that extends between the first opener linking bar 226 and the third opener linking bar 227. The position of the anchor bar 242 may be adjustable as further described below.

The biasing member 240 may exert a force directly between the parallel linkage 220 and the mounting plate 114, with a resultant force on the opener frame 210 of the furrow opener assembly 200 represented as F1, i.e., downward and effectively normal to the surface of the field 400, regardless of the pitch of slope of the field at any particular location. The parallel linkage 220 is connected between the opener frame 210 and the frame bracket 110 such that the parallel linkage 220 maintains an angular orientation of the opener frame 210 with respect to the planter frame 75. This angular orientation may be generally or substantially orthogonal to the effective downward force F1 of the adjustable biasing member 240. While the actual force exerted by the biasing member 240 may not be entirely downward or normal to the field 400 as indicated in FIGS. 3 and 4, the interaction between the biasing member 240 and the parallel linkage 220 may result in a primarily downward force on the opener frame 210. This downward force may counteract upward forces on the furrow opener assembly (e.g., rocks, hard pack soil, ridges, or humps in the field 400). The biasing member 240 thereby helps maintain a downward force (in addition to the weight of the furrow opener assembly 200) on the opener frame 210 and all implements attached thereto (e.g., the opener wheel 260 and the gauge wheel 265) against the ground 400.

As noted, in any of the embodiments, the position of the first end of the biasing member 240 may be adjustable along a length of the upper portion of the parallel linkage 220. The adjustment in position of the first end of the biasing member 240 (e.g., when a tension spring) allows for the resting tension on the parallel linkage 220 to be increased or decreased. For example, as shown in FIGS. 3 and 4, the anchor bar 242 may connect to the parallel linkage 220 at any of a variety of positions along about 50% of the lengths of the first linking bar 226 and the third linking bar 227. As shown, elongate slots 250 may be formed in the walls of the first linking bar 226 and the third linking bar 227 into which lateral ends of the anchor bar 242 are positioned. A bottom surface of the elongate slots 250 may be formed as a plurality of detents 251. The lateral ends of the anchor bar 242 may engage the elongate slots 250 and seat within any opposing pair of detents 251. The anchor bar 242 may be sized to slide within and along the elongated slot between the detents 251. The biasing member 240 pulls on the anchor bar 242 and holds it in place in a selected pair of detents 251 in the slots 250. The anchor bar 242 may be a shaft or rod or pin that extends between the first linking bar 226 and the third linking bar 227.

In any embodiment contemplated herein, the opener frame 210 may include an adjustment mechanism 255 operable to change the position of the gauge wheel 265 relative to the opener frame 210. The adjustment mechanism 255 may be operated by an adjustment lever, which raises or lowers the gauge wheel 265. A linkage may extend between a bottom end of the lever and the opener frame 210. The position of the adjustment mechanism 255 may be configured to set the gauge wheel 265 at a desired position relative to the opener frame 210. The adjustment mechanism 255 thus sets the depth of furrows 402 created by the opener disc 260 by adjusting the vertical position of the gauge wheel 265 relative to the opener frame 210 and the opener disc 260. The position of the gauge wheel 265 also affects the static position of the opener frame 210 with respect to the planter frame 75 and thus can affect the tension exerted by the biasing member 240.

The trailing arm assembly 100 may also include a furrow closer assembly 300 that supports implements operable to close and/or fertilize a furrow 402. As shown in FIGS. 3 and 4, the furrow closer assembly 300 may include a closer frame 310. The opener frame 210 and the closer frame 310 may be connected to one another such that the closer frame 310 may operatively move independently with respect to the opener frame 210 such that the furrow closer assembly 300 may articulate vertically relative to the opener trailing arm assembly 200. One or more closing wheels 360 may be rotationally mounted to the closer frame 310. The closing wheels 360 may generally operate at a similar level as the gauge wheels 265 to close the furrows 402 rather than at the lower depth of the opener disc 260 that cuts the furrows 402. In some embodiments (not shown herein), the closer frame 310 may also support a fertilizer disc and/or a fertilizer distribution system.

In any of the embodiments disclosed herein, the closer frame 310 may be connected to the opener frame 210 via a second parallel linkage 320. The second parallel linkage 320 may have a first closer linking bar 326 and a second closer linking bar 328. The first closer linking bar 326 may be pivotably connected at a first end on a first closer pivot bearing 330 to the opener frame 210. The first closer linking bar 326 may be pivotably connected at a second end on a second closer pivot bearing 332 to the closer frame 310. In this arrangement, the first closer linking bar 326 allows movement between the opener frame 210 and the closer frame 310. The second closer linking bar 328 may be pivotably connected at a first end on a third closer pivot bearing 334 to the opener frame 210. The second closer linking bar 326 may be pivotably connected at a second end on a fourth closer pivot bearing 336 to the closer frame 310.

The first closer linking bar 326 and the second closer linking bar 328 may be positioned in parallel relative to one another such that planes passing through the first and second closer pivot bearings 330, 332 and the third and fourth closer pivot bearings 334, 336, respectively, are parallel to one another. In this relationship, as the first closer linking bar 326 and the second closer linking bar 328 articulate through their range of motion, they remain parallel to one another. The parallel linkage 220 of the furrow opener assembly 200 provides a first degree of articulation for movement of the components positioned rearward of furrow opener assembly 200, e.g. the closing assembly 300. The second parallel linkage 320 of the closing assembly 300 provides a second degree of articulation that is independent of the opener assembly 200 and provides additional vertical range of movement for the closing wheels 360a, 360b.

In any embodiment, for example, as shown in FIG. 3, the second parallel linkage 320 may also include a third closer linking bar 327 and a fourth closer linking bar 329 that are spaced apart from the first closer linking bar 326 and the second closer linking bar 328, respectively, and are positioned as mirror opposites thereof. The third closer linking bar 327 and the fourth closer linking bar 329 may be attached to the opener frame 210 at first ends and to the closer frame 310 at second ends on pivot bearings located on the same axes as the pivot axes of the first, second, third, and fourth closer pivot bearings 330, 332, 334, 336, respectively. In any embodiment, the first and second closer pivot bearings 330, 332 may be shafts supported by the opener frame 210 to extend between and support both the first closer linking bar 326 and the third closer linking bar 327. Similarly, in any embodiment, the third and fourth closer pivot bearings 334, 336 may be shafts supported by the closer frame 310 to extend between and support both the second closer linking bar 328 and the fourth closer linking bar 329.

In the prior art embodiment shown in FIGS. 3 and 4, the closer frame 310 may include a closer mounting bracket 316 fixedly attached or removably attachable to the opener frame 210. The closer frame 310 may be movably attached to the closer mounting bracket 316 via the second parallel linkage 320, preferably in a manner that provides stability to the sides of the second parallel linkage 320 to minimize twisting of the furrow closer assembly 300. The closer mounting bracket 316 may also include a closer mounting plate 314 that connects to a biasing member 340. The closer mounting plate 314 may be located above, below, or in between pivots 330 and 332. As shown in FIGS. 3 and 4, the closer mounting plate 314 may be below the third closer pivot 334 and also extend downward beyond or bend under the second closer linking bar 328 and the fourth closer linking bar 329. By extending outward and under the second linking bar 328 and the fourth linking bar 329, the closer mounting plate 314 may be positioned to stop the parallel linkage 320 from allowing rotation beyond a certain point. For example, the closer mounting plate 314 may limit the travel of the second closer linking bar 328 and the fourth closer linking bar 329 by being positioned to contact the second closer linking bar 328 and the fourth closer linking bar 329 at a chosen angular orientation.

In any contemplated implementation, the first closer linking bar 326 and the third closer linking bar 327 of the second parallel linkage 320 may be rigidly connected, for example, welded together with a cross-brace plate 322 to form a unitary structure. Similarly (although not presented in the figures), the second closer linking bar 328 and the fourth closer linking bar 329 may be rigidly connected, for example, welded together with a cross-brace to form a unitary structure. Such unitary formation may increase the lateral rigidity of the second parallel linkage 320. The unitary formation of either or both the upper and lower closer linking bars 326, 327, 328, 329 may be accomplished by means other than cross bracing. For example, each pair of linking bars may be cast, molded, machined, stamped, welded, or formed together by any other method as a single piece. In any embodiment, the closer mounting bracket 316 may be fixedly attached to (but generally removable from) the opener frame 210. The closer mounting bracket 316 may provide stability proximal to the sides of the second parallel linkage 320 such that twisting of the furrow closer assembly 300 is minimized. Further, the closer frame 310 may be formed as a rigid box structure that also provides external stability to the second parallel linkage 320 as the third and fourth closer pivot bearings 334, 336 are attached thereto.

In the prior art embodiment of FIGS. 3 and 4, a biasing member 340 is mounted between the parallel linkage 320 and the closer mounting plate 314 and, thus, with respect to the opener frame 210. In various known embodiments, the biasing member 340 can be a tension spring, a torsion spring positioned around the third closer pivot bearing 334, or a hydraulic or pneumatic cylinder operable to extend or contract. In the embodiment shown, the biasing member 340 is a heavy gauge tension spring that is connected at a first end to the first closer linking bar 326 and the third closer linking bar 327 of the second parallel linkage 320 and at a second end to the closer mounting plate 314. In this manner, the second end of the biasing member 340 has little or no movement relative to the opener frame 210. In some embodiments, the first end of the biasing member 340 may be connected to the cross brace plate 322 extending between the first closer linking bar 326 and the third closer linking bar 327 forming a unitary upper bar of the parallel linkage 320. In other embodiments, as shown in FIGS. 3 and 4, the first end of the biasing member 340 may be connected to a separate anchor lever 342 positioned between the first closer linking bar 226 and the third closer linking bar 227. The position of the anchor lever 342 may be adjustable as further described below.

The biasing member 340 may exert a force directly between the second parallel linkage 320 and the closer mounting plate 314, with a resultant force on the closer frame 210 of the furrow closer assembly 300 represented as F2, i.e., downward and effectively normal to the surface of the field 400, regardless of the pitch of slope of the field 400 at any particular location. The second parallel linkage 320 is connected between the closer frame 310 and the closer mounting bracket 314 such that the second parallel linkage 320 maintains an angular orientation of the furrow closer assembly 300 with respect to the opener frame 210. This angular orientation may be generally or substantially orthogonal to the effective downward force F2 of the biasing member 340. While the actual force exerted by the biasing member 340 may not be entirely downward or normal to the field 400 as indicated in FIGS. 3 and 4, the interaction between the biasing member 340 and the second parallel linkage 320 may result in a primarily downward force on the closer frame 310. This downward force may counteract upward forces on the furrow closer assembly 300 (e.g., rocks, hard pack soil, ridges, or humps in the field 400). The biasing member 340 thereby helps maintain a downward force (in addition to the weight of the furrow closer assembly 300) on the closer frame 310 and all implements attached thereto (e.g., the closer wheels 360) against the field 400.

As noted, in any of the embodiments, the position of the first end of the second biasing member 340 may be adjustable along a length of the upper portion of the second parallel linkage 320. The adjustment in position of the first end of the second biasing member 340 (e.g., when a tension spring) allows for the tension on the second parallel linkage 320 to be increased or decreased. For example, as shown in FIGS. 3 and 4, the anchor lever 342 may have an upper end with a handle and a lower end that connects with the first end of the second biasing member 340. A mid-portion of the anchor lever 342 may be pivotably mounted with respect to the second parallel linkage 320, e.g., mounted to rotate about the second closer pivot bearing 332 (not visible). The second closer pivot bearing thus acts as a fulcrum for the anchor lever 342 to increase or reduce the static tension on the second biasing member 340. The upper end of the anchor lever 342 may interface with the cross brace plate 322 on the second parallel linkage 320 at any of a variety of positions along about 50%-80% of the lengths of the first closer linking bar 326 and the third closer linking bar 327. As shown, an elongate slot 350 may be formed in the wall of the cross brace plate 322 within which the anchor lever 342 is positioned. The sides of the elongate slot 350 may be formed with a plurality of detents 351. The anchor lever 342 may engage the elongate slot 350 and seat within any detent 351 along the length of the elongate slot 350, pivoting about the second closer pivot bearing 332 and thus moving the lower end of the anchor lever 342 farther from or nearer to the closer mounting bracket 314, thereby increasing or decreasing tension in the second biasing member 340. The second biasing member 340 pulls on the anchor lever 342 and holds it in place in a selected detent 351 in the slot 350.

New implementations of a second parallel linkage 520 and components thereof for use with a furrow closing assembly 500 are depicted in FIGS. 5A-10. In these implementations, the downward force of the biasing member is provided by a linear actuator 540. The linear actuator 540 may be an electro-mechanical, screw-drive linear actuator. For example, the linear actuator may be an actuator of various configurations that use an electric motor to convert rotary motion into linear displacement. In one example, the linear actuator may include a configuration in which a threaded lead screw is engaged with a nut having corresponding threads. The lead screw may be rotated axially by operation of an associated electric motor. The rotation of the lead screw may drive the nut along the axial length of the lead screw. The nut may be fixedly engaged with an external shaft, thrust tube, casing or other component that may be driven axially, reciprocally based on the advancement of the nut along the lead screw. It will be appreciated that the substantially any other arrangement of mechanical mechanisms may be used to facilitate the conversion of rotary motion from the electric motor to linear motion of a shaft or tube, including other screw-type mechanisms, such as ball screws, roller screws and so on. Wheel and axle type combination may be used in other examples in which a wheel component rotate in order to produce linear motion from a belt or chain. Additionally or alternatively, cam-based linear actuator may be used, particular for low-travel applications.

Use of a linear actuator 540 provides a number of benefits over the prior art biasing mechanisms such as springs or hydraulic or pneumatic rams. Significant benefits include faster response time, smart and prescriptive control of furrow closing assemblies 500 from the tractor cab, individual force control on a row-by row basis, immediate feedback for force adjustment, control of extension length of the screw post in the actuator, and ability to lift the furrow closing assembly 500 over obstacles among others. In this regard, the linear actuator 540 may be used to control downforce with respect to individual furrow closing assemblies 500 of an example planter. The individual force control may provide for more consistent downforce by adjusting the force in response to real-time field conditions. For example, and as described herein, a load cell or other measurement or feedback device may be integrated with the linear actuator 540. The load cell may be configured to detect a change in force at the closing assembly 500 (e.g., at the linear actuator 540), such as due to a change in contour of the field or other field conditions. In turn, the linear actuator 540 may be adjusted, in some cases, automatically, in order to exert more or less force on the associated parallel linkage 520. The linear actuator 540 therefore may be used to maintain a relative consistent or constant downforce on the parallel linkage 520, as described herein below.

FIGS. 5A and 5B depict a basic embodiment of a furrow closing assembly 500 incorporating the linear actuator 540. As in the prior art embodiments, the furrow closing assembly 500 may be built around a closer frame 510. The closer frame 510 may be connected to the opener frame 210 such that the closer frame 510 may operatively move independently with respect to the opener frame 210 and allow the furrow closer assembly 500 to articulate vertically relative to the opener trailing arm assembly 200. One or more closing wheels 560a, 560b may be rotationally mounted to the closer frame 510. The closing wheels 560a, 560b may generally operate at a similar level as the gauge wheels 265 to close the furrows 402 rather than at the lower depth of the opener disc 260 that cuts the furrows 402. In some embodiments (not shown herein), the closer frame 510 may also support a fertilizer disc and/or a fertilizer distribution system.

In any of the embodiments disclosed herein, the closer frame 510 may be connected to the opener frame 210 via a second parallel linkage 520. The closer frame 510 may include a closer mounting bracket 516 fixedly attached (either permanently or removably) to the opener frame 210. The closer frame 510 may be movably attached to the closer mounting bracket 516 via the second parallel linkage 520, preferably in a manner that provides stability to the sides of the second parallel linkage 520 to minimize twisting of the furrow closer assembly 500. The second parallel linkage 520 may have a first closer linking bar 526 and a second closer linking bar 528. The first closer linking bar 526 may be pivotably connected at a first end on a first closer pivot bearing 530 to the closer mounting bracket 516. The first closer linking bar 526 may be pivotably connected at a second end on a second closer pivot bearing 532 to the closer frame 510. In this arrangement, the first closer linking bar 526 allows movement between the opener frame 210 and the closer frame 510. The second closer linking bar 528 may be pivotably connected at a first end on a third closer pivot bearing 534 to the closer mounting bracket 516. The second closer linking bar 528 may be pivotably connected at a second end on a fourth closer pivot bearing 536 to the closer frame 510.

The first closer linking bar 526 and the second closer linking bar 528 may be positioned in parallel relative to one another such that planes passing through the first and second closer pivot bearings 530, 532 and the third and fourth closer pivot bearings 534, 536, respectively, are parallel to one another. In this relationship, as the first closer linking bar 526 and the second closer linking bar 528 articulate through their range of motion, they remain parallel to one another. The parallel linkage 220 of the furrow opener assembly 200 provides a first degree of articulation for movement of the components positioned rearward of furrow opener assembly 200, e.g. the closing assembly 500. The second parallel linkage 520 of the closing assembly 500 provides a second degree of articulation that is independent of the opener assembly 200 and provides additional vertical range of movement for the closing wheels 560a, 560b.

In any embodiment, for example, as shown in FIGS. 5A and 5B, the second parallel linkage 520 may also include a third closer linking bar 527 and a fourth closer linking bar 529 that are spaced apart from the first closer linking bar 526 and the second closer linking bar 528, respectively, and are positioned as mirror opposites thereof. The third closer linking bar 527 and the fourth closer linking bar 529 may be attached to the closer mounting bracket 516 at first ends and to the closer frame 510 at second ends on pivot bearings located on the same axes as the pivot axes of the first, second, third, and fourth closer pivot bearings 530, 532, 534, 536, respectively. In any embodiment, the first and second closer pivot bearings 530, 532 may be shafts supported by the closer mounting bracket 516 to extend between and support both the first closer linking bar 526 and the third closer linking bar 527. Similarly, in any embodiment, the third and fourth closer pivot bearings 534, 536 may be shafts supported by the closer frame 510 to extend between and support both the second closer linking bar 528 and the fourth closer linking bar 529.

As shown in FIGS. 5A and 5B, the closer mounting bracket 516 may also include a closer mounting plate 514 that connects to the base of the linear actuator 540. The closer mounting plate 514 may be located above, below, or in between pivots 530 and 532. As shown in FIGS. 5 and 4, the closer mounting plate 514 may be below the third closer pivot 534 and also extend downward beyond or bend under the second closer linking bar 528 and the fourth closer linking bar 529. By extending outward and under the second linking bar 528 and the fourth linking bar 529, the closer mounting plate 514 may provide a platform for mounting the base of the linear actuator 540 thereon.

In any contemplated implementation, the first closer linking bar 526 and the third closer linking bar 527 of the second parallel linkage 520 may be rigidly connected, for example, welded together with a cross-brace plate 522 to form a unitary structure. Similarly (although not presented in the figures), the second closer linking bar 528 and the fourth closer linking bar 529 may be rigidly connected, for example, welded together with a cross-brace to form a unitary structure. Such unitary formation may increase the lateral rigidity of the second parallel linkage 520. The unitary formation of either or both the upper and lower closer linking bars 526, 527, 528, 529 may be accomplished by means other than cross bracing. For example, each pair of linking bars may be cast, molded, machined, stamped, welded, or formed together by any other method as a single piece. In any embodiment, the closer mounting bracket 516 may be fixedly attached to (but generally removable from) the opener frame 210. The closer mounting bracket 516 may provide stability proximal to the sides of the second parallel linkage 520 such that twisting of the furrow closer assembly 500 is minimized. Further, the closer frame 510 may be formed as a rigid box structure that also provides external stability to the second parallel linkage 520 as the third and fourth closer pivot bearings 534, 536 are attached thereto.

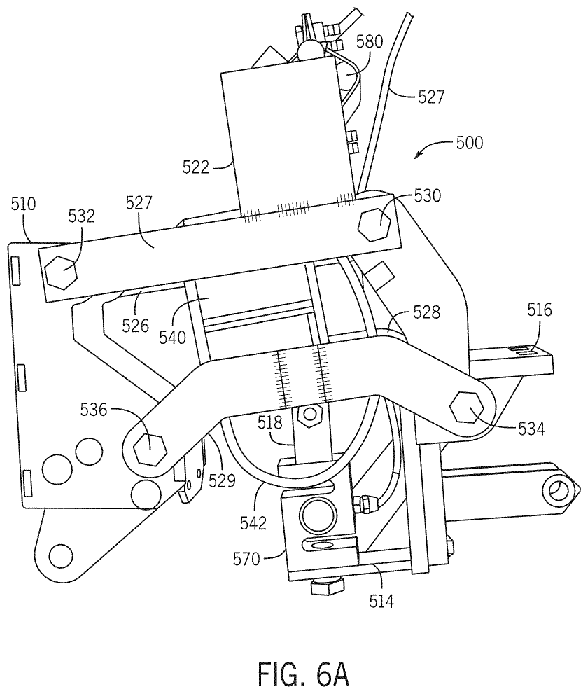

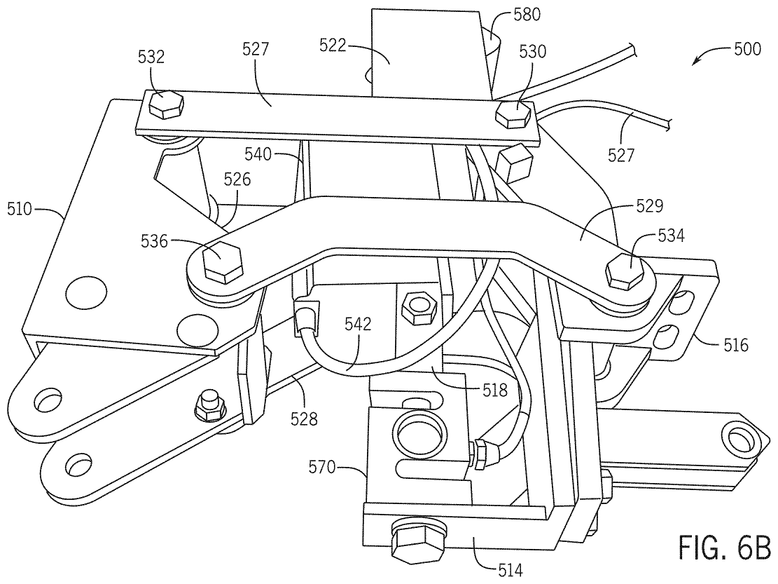

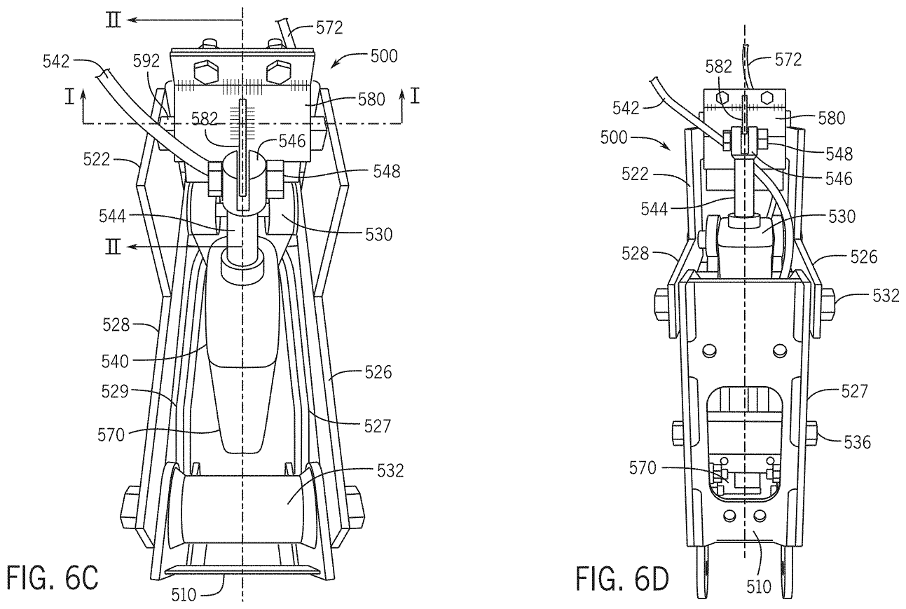

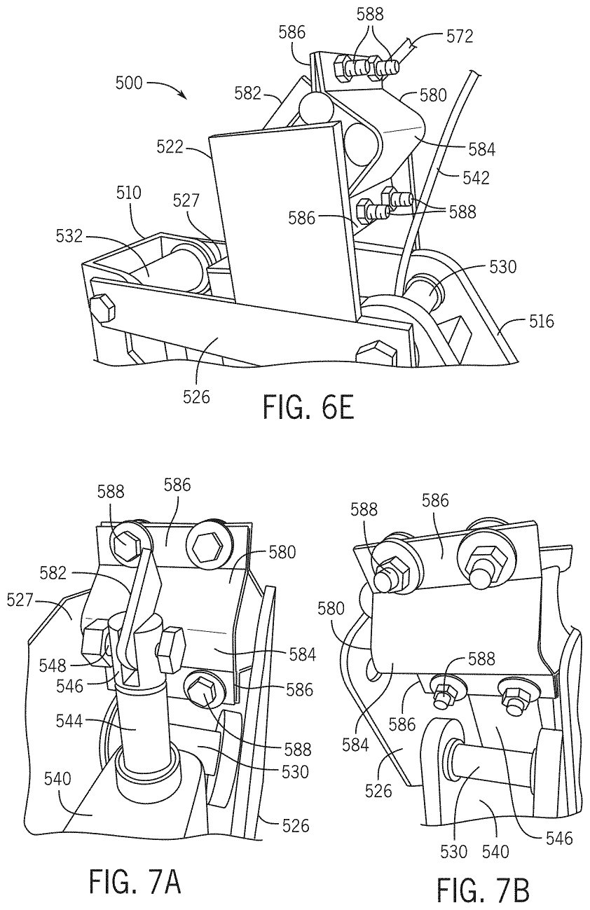

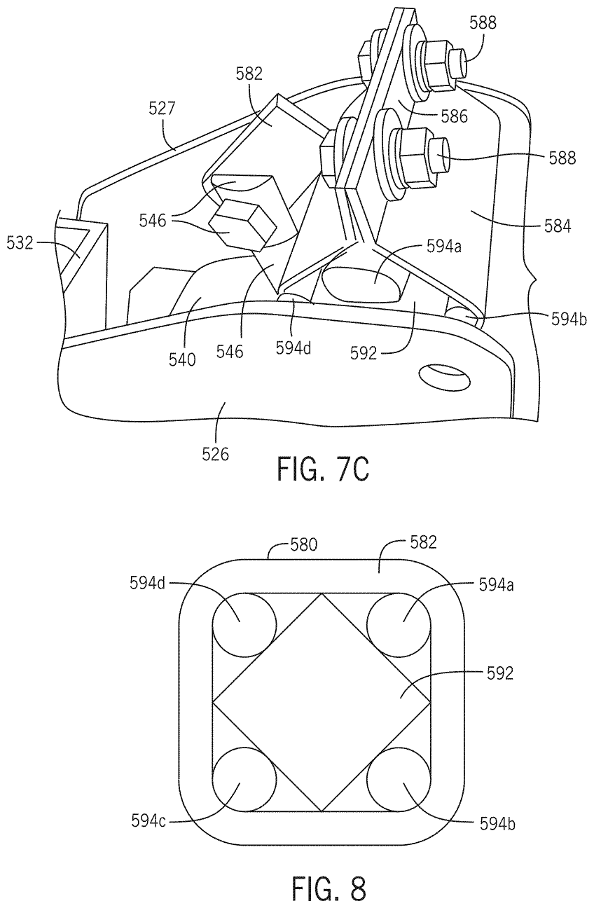

As noted, the base of the linear actuator 540 may be mounted on the closer mounting plate 514, which is a stable surface with respect to the furrow opener assembly 200, as the closer mounting plate is rigidly attached to the closer mounting bracket 516, which in turn is rigidly mounted to the opener frame 210 of the furrow opener assembly 200. The base of the linear actuator 540 encases the motor and drive mechanisms that extend a shaft linearly outward from the base. (The shaft of the linear actuator 540 is not visible in FIGS. 5A and 5B, but is shown in FIGS. 6C, 6D, 7A, and 7C herein.) In this embodiment, the shaft of the linear actuator 540 is pivotably connected to the cross-brace plate 522 (not visible in FIGS. 5A and 5B).

A control wire bundle 542 is attached to the linear actuator 540 to provide power and control signals thereto. The control wires in the control wire bundle 542 may extend to the cab of the tractor 50 and connect with electronic and software driven control systems mounted therein. Alternatively, the control wires in the control wire bundle 542 may connect with a wireless transceiver (not shown) mounted on the row unit of the trailing arm assembly 100 to provide wireless communication with electronic and software driven control systems mounted in the cab of the tractor 50 or elsewhere. A power wire in the control wire bundle 542 may be connected to a battery or other power source on the tractor 50 to provide operational power to the linear actuator 540. In some implementations, the software control system may be provided with prescriptive mapping information about a field 400 that indicates areas of soft vs. hard or compacted soils, if known. This information can be collected based upon surveys or prior experience planting the particular field 400. The control software can thus be preprogrammed to control the forces on the linear actuator 540 based upon the position of the tractor 50 in the field 400, e.g., as determined by global positioning satellite (GPS) information received by an integrated GPS system in the tractor 50.

Control signals sent to the linear actuator 540 through the control wire bundle 542 may direct the internal mechanical drive mechanism to extend or retract the shaft 544. Uniform control signals can be sent to each linear actuator 540 of each row assembly on the planter or the control software can send individual control signals with separate direction to each of the linear actuators 540 on the planter. When the shaft 544 is extended, it presses against the cross-brace plate 522 and thus drives the closer frame 510 downward due to the pivot motion provided by the second parallel linkage 520. While the shaft 544 may only extend a few inches, the four bar configuration of the second parallel linkage 520 and the much longer lengths of the closer linking bars 526, 527, 528, 529 translates the short extension of the shaft 544 into a much longer range of travel. For example, 2 inches of extension of the shaft 544 can translate into 6-8 inches or more of vertical travel for the closer frame 510 (and thereby the attached closer wheels 560a, 560b) depending upon the lengths of the closer linking bars 526, 527, 528, 529 in the second parallel linkage 520. Further, if a closer wheel 560a, 560b or press wheel is further attached to a walking arm beam (e.g., as described in U.S. Patent Application Publication No. 2017/0208736), an additional 2 inches of vertical travel is achievable for a total of about 9 inches of vertical movement of implements attached to the furrow closer assembly 500.

When the shaft is retracted, it may pull the closer frame 510 upward, thereby lifting the closer wheels 560a, 560b above the surface of the field 400. When the linear actuator 540 is in the retracted position, the furrow closer assembly 500 is raised above the field 400 and the tractor 50 can be driven at a faster speed for moving between fields or can avoid impacts to the furrow closer assembly when traveling over irrigation troughs, through drainages, swales, or culverts, or over terraces.

The linear actuator 540 may provide between 50 and 150 pounds or more of downward force or lift force on the furrow closing assembly 500 in a very short, reactive period of time. It is preferable that the linear actuator be an electromechanical device with a screw drive in order to provide adequate force and static resistance to external forces. For example, in one embodiment, the linear actuator 540 can exert or pull 125 pounds of force on the closer frame 510 and the shaft can travel 1.78 inches in one second, with a full extension stroke of 2 inches.

Under software control, such a linear actuator 540 provides an extremely fast, substantially instantaneous, operation and reaction time as compared to prior art hydraulic and pneumatic implementations for biasing furrow closer assemblies. Additionally, hydraulic and pneumatic biasing implementations require a pressure source and fluid lines to connect with the hydraulic or pneumatic pistons to provide fluid or air for control. The travel distance of such fluids, usually from a compressor source for the entire planter is a significant factor in delayed responsiveness as compared to the linear actuators 540 described herein. Assembly and maintenance of hydraulic or pneumatic pistons and associated pumps and compressors is significantly more difficult as well. Further, by setting limit switches on the linear actuator 540 or in control software, the range of travel or pressure applied by a linear actuator 540 can be set in very granular increments for any particular application, something that cannot be done with prior art spring implementations, and difficult to do with precision (if at all) with prior art hydraulic and pneumatic implementations, for biasing furrow closer assemblies. With that said, self-contained hydraulic ram cylinders powered by 12 volt DC are now available and could be substituted for a screw-driven linear actuator 540, allowing for individual row unit control as disclosed herein, but the response time for travel of a shaft or piston of such an electric hydraulic ram is still slower than the linear actuator 540, which is thus preferable.

An alternative embodiment of the second parallel linkage 520 including a linear actuator 540 for use with a furrow closer assembly 500 is depicted in FIGS. 6A-6E. The parallel linkage 520 in this embodiment is substantially the same as shown in FIGS. 5A and 5B. However, two additional components have been added to the parallel linkage 520 to operate in conjunction with the linear actuator 540 and provide additional functionality to the control of the closer furrow assembly 500. The first additional component may be a torsion axle 580 mounted to a torsion frame 522 fixed to and extending upward from the first closer linking bar 526 and the third closer linking bar 527. An alternative embodiment of the second parallel linkage 520 is depicted in FIGS. 7A-7C. In this embodiment, the first and third closer linking bars 526, 527 are formed as extended plates with sufficient surface area for the torsion axle 580 to mount therebetween. The torsion axle 580 is further pivotably connected to the shaft 544 of the linear actuator 540.

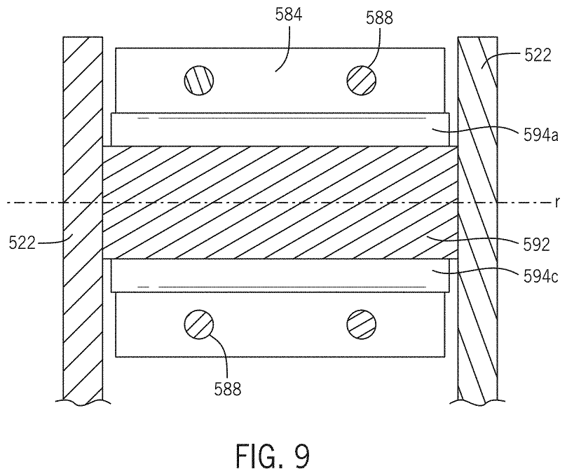

The torsion axle 580 is further shown schematically in cross section in FIG. 8. In any embodiment, the torsion axle 580 may be formed about a torsion block 592 fixedly attached between the torsion frame 522 extending above the first closer linking bar 526 and the third closer linking bar 527. For example, as shown in the cross-sectional view of FIG. 9, the torsion block 592 may be fixedly attached to the torsion frame 522. The torsion frame 522 is fixedly attached to the closer bars 526, 527 of the parallel linkage 520. In other cases, the torsion block 592 may be directly fixed to the first and third closer linking bars 526, 527 as shown in FIGS. 7A-7C. The torsion block 592 may be a piece of square steel block or square steel tube welded at each end to the torsion frame 522 or the first and third closer linking bars 526, 527. Torsion biasing members 594a-594d may be positioned on each flat side of the torsion block 592. Exemplary torsion biasing members 594a-594d may be hard rubber cylinders or similar dense, elongated elastomeric bumpers arranged about and along the walls of the torsion block 592.

The torsion biasing members 594a-594d may be held in place by a torsion case 584 formed as a steel tube of square cross section surrounding the torsion biasing members 594a-594d and the torsion block 592. The walls of the torsion case 584 may be parallel to the walls of the torsion block 592. In one implementation, the torsion case 584 make be formed by two pieces of angle steel with pieces of flat steel welded to the long edges of the angle steel to form flanges 586. The flanges 586 may form an angle of 270° with the outer walls of the torsion case 584. Opposing flanges 586 along each edge of the angle steel may be placed flush against each other. Two or more through holes may be bored in each piece of flange 586 with opposing through holes aligned with each other. Corresponding case fasteners 588, e.g., steel bolts, may be placed through the through holes to hold the two halve of the torsion case 584 together. The torsion case 584 thus holds the torsion biasing members 594a-594d tightly, but without significant compression, against the walls of the torsion block 592. The square cross-section perimeter of the torsion case 584 formed by the walls of angle steel is this larger than the square perimeter of the torsion block 592 and the torsion case 584 thus fits concentrically about the torsion block 592.

The arrangement of the torsion case 584, biasing members 594a-594d, and torsion block 592 may permit relative movement between the torsion case 584 and the torsion block 592 about an axis r, as shown in FIG. 9. For example, the torsion block 592 may be fixed to the frame 522 and define the axis r. The biasing members 594a-594d may be arranged about the torsion block 592 and the axis r. The torsion case 584 may be clamped around the biasing members 594a-59d, as described herein. The torsion case 584 may be clamped around the biasing members 594a-594d such that the torsion case 584 and the torsion block 592 may rotate relative to one another about the axis r in response to a force input. The biasing members 594a-594d may impede or prevent such relative rotation based, in part, on the elastic characteristics of the biasing members 594a-594d. In this regard, the torsion axle 580 may provide damping or flexibility in the system between the parallel linkage 522 and the actuator 540. For example, and as described below, the linear actuator 540 may be connected to the torsion case 584 and exert a force on the parallel closer 540 via the torsion axle 580. The relative movement of the torsion case 584 and the torsion block 592 permitted by the biasing members 594a-594d may allow for variation in force received at the parallel linkage 520 (e.g., due to an abrupt grade change, field debris, or the like) to be absorbed at least partially by the torsion axle 580 (and biasing members 594a-594d) as opposed to encountering rigid resistance at the shaft of the linear actuator 540.

In other embodiments the torsion axle may be formed as a torsion spring around a shaft. However, for applications in an agricultural planter 70, such construction may not be adequately robust to withstand the jarring forces as the furrow closer assembly travels across the field.

As shown in FIGS. 6A-6E, a coupler plate 582 extends from the rear side of the torsion case 584. The coupler plate 582 may be a piece of flat steel oriented vertically and welded to angle steel on the rear side of the torsion case 582. A through hole may be bored through the coupler plate 582. As shown in FIGS. 6A-6D, the distal end of the shaft 544 of the linear actuator 540 may be formed as a yoke 546 with a channel defined therein to define an arm on either side of the channel. Through holes may be bored in each arm of the yoke 546 transverse to the channel. The coupler plate 582 is aligned as a knife with the channel and the through holes in each of the arms of the yoke 546 align with the hole in the coupler plate 582. A coupler pin 548 extends through the through holes of each of the yoke 546 and the coupler plate 582 to pivotably connect the torsion axle 580 to the shaft 544 of the linear actuator 540. The coupler pin 549 is thus connected in double shear between the yoke 546 and the coupler plate 582.

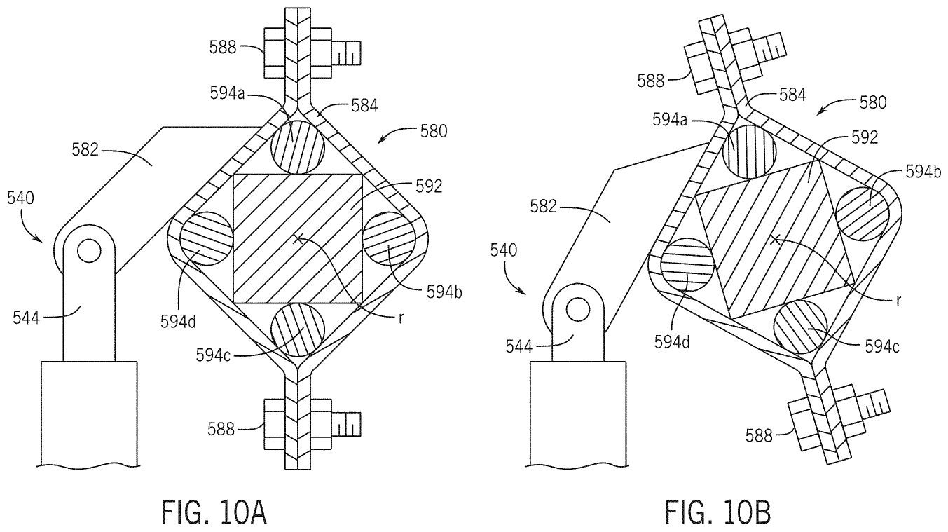

The torsion axle 580 is designed to be stiff enough to resist the exertion or retraction force of the shaft 544 of the linear actuator 540 within desired parameters. For example, if it the typical range of downward force applied or upward impact force encountered is up to 50 pounds, the torsion axle 580 can be designed (e.g., by selection of materials for torsion bumpers 594a-594d of elastic modulus) such that the torsion axle 580 remains substantially static until an impact or pull of greater than 50 pounds of force is exerted. For example, and with reference to the cross-sectional view of FIG. 10A, the torsion axle 580 may be configured to remain static for up to 50 pounds of force exerted on the parallel linkage 520. If the furrow closer assembly 500 impacts a hard surface or is otherwise subjected to a significant opposing force, the torsion axle 580 will absorb the excess force (up to 200 pounds in an exemplary embodiment) and provide additional travel for the linear actuator 540 as the torsion axle 580 twists under the load, thereby preventing damage to the linear actuator 540. For example, and with continued reference to FIG. 10A, the torsion block 592 and the torsion case 584 may twist or rotate about the axis r relative to one another under the additional load. The torsion block 592 and the torsion case 584 may twist in this regard with the shaft 544 remaining at a generally constant length. As such, the torsions axle 580 absorbs the additional load rather than shaft 544, which may help prevent damage to the linear actuator 540.

When the linear actuators 540 on the furrow closer assembly 500 are not operating (i.e., no voltage is applied, e.g., when the planter 70 is merely in transport or is transitioning between terraces or traveling through drainages or culverts or swales between rows), the torsion axle 580 provides a safety bias to absorb the impact of jolts and jars on the furrow closer assembly 500. An upward force on the furrow closer assembly 500 translated to the linear actuator 540 via the closer frame 510 impacts the coupler plate 582 through the shaft 544. The coupler plate 582 translates the force to the torsion case 584 which rotates against the torsion bumpers 594a-594d and compresses them against the stationary torsion block 592 to absorb the force. The rotation of the torsion case 584 also allows for a small amount of travel for the linear actuator 540, which further helps prevent damage. The torsion bumpers 594a-594d then decompress and return the torsion case 584 to its original position. The torsion axle 580 can thus help prevent damage to the linear actuators 540 when they are in static positions not under control of the controls system.

It will be appreciated that the torsion axle 580 may provide flexibility and damping for the linear actuator 540 for a range of linear extensions of the shaft 544. For example, and with reference to FIG. 10B, the linear actuator 540 is shown with the shaft 544 in a retracted position as compared to the arrangement of FIG. 10A. The torsion axle 580 may be rotated, as a unit, about the axis r, as a result of the retracted position of the shaft 544. Substantially analogous to the example as described with respect to FIG. 10B, the torsion axle 580 may twist or rotate about the axis r relative to one another under the additional load. This may impart damping or flexibility into the system that may reduce the potential for damage to the linear actuator 540.

Additionally, the torsion axle 580 can provide a safety release for the linear actuator 540 when operational, for example, if the closer wheels 560a, 560b or other attached implements encounter an unforeseen obstacle (e.g., a rock or extremely hard soil) and imparts a significant force in an instant before any feedback can recognize the impact and can adjust. Further, the torsion axle 580 may allow the user of the agricultural planter 70 to operate the furrow closer assembly 500 without operational control of the linear actuator 540 without removing and replacing the furrow closer assembly 500. For example, if the user wants to drive the tractor 50 at a greater speed than a response speed of the linear actuators 540, then the linear actuators 540 can be placed in an extended position to place the closing wheels 560a, 560b against the furrows 402 for closing. If the furrow closer assembly 500 encounters an obstacle or impact, the torsion axle 580 can absorb the force and prevent damage to the linear actuators 540.

The second additional component to the second parallel linkage 520 in the embodiment of FIGS. 6A-6E may be a load cell 570 mounted to the closer mounting plate 514 between the closer mounting plate 514 and the base of the linear actuator 540. As shown in FIGS. 6A and 6B, an additional mounting pillar 518 may be positioned between the base of the linear actuator 540 and the top of the load cell 570. The mounting pillar 518 may be fixedly, but removably, connected to each of the linear actuator 540 and the load cell 570, e.g., with bolts or other fasteners, to allow for ease of removal and replacement of the components should they become damaged or wear out. A load sensor wire 572 is connected to the load cell 570 and provides a signal to the control system in the cab of the tractor 50, either through a direct connection or by connecting to a wireless transceiver as discussed above with respect to the control wire assembly 542 for the linear actuator 540. The load cell 570 may be selected for appropriate sensitivity as well as robustness for the application. For example, for use with the furrow closing system 500 on an agricultural planter 70 that encounters significant forces (e.g., bangs, bumps, drops, rocks, compacted soil, etc.), a robust load cell 570 with a 1 ton capacity and 1 pound measurement increments may be desirable.

The load cell 570 senses the force actually present between the closer frame 510 and the furrow 402 in the field 400. The load cell may measure the total force on the load cell 570, or it may provide measurements of instantaneous differential forces generated by the linear actuator 540 or by interaction of implements (e.g., closer wheels 560a, 560b) with the surface of the field 400 and translated to the closer frame 510, or both. By measuring the force differential between the upward forces from the field 400 and the downward force exerted by the linear actuator 540 using the load cell 570, feedback can be provided to the control system for adjustment of the force provided by the linear actuator 540. For example, if a closing force of 20 pounds on the closing wheels 560a, 560b is desired to properly close the furrow 402 for best practice seed coverage and emersion, and if the ground is soft with little resistance, a downward force of 20 pounds (or less when considering the force due to the weight of the furrow closer assembly 500) may be applied by the linear actuator 540. However, if the soil is highly compacted and is exerting a substantially higher resistance force as sensed by the load cell 570, the control system can be programmed to automatically increase the exertion force of the linear actuator 540 to counteract the resistance force and apply a net downward force of 20 pounds to close the furrows 402. For example, if the soil resistance force is measured by the load cell 570 to be 10 pounds, the control system may direct the linear actuator 540 to exert a force of 30 pounds to achieve a net downward force of 20 pounds for furrow closure.

Although various representative embodiments of agricultural planters have been described herein with a certain degree of particularity, those skilled in the art could make numerous alterations to the disclosed embodiments without departing from the scope of the inventive subject matter set forth in the specification and claims. The various embodiments discussed herein are not exclusive to their own individual disclosures. Each of the various embodiments may be combined with or excluded from other embodiments. All directional references (e.g., proximal, distal, upper, lower, upward, downward, left, right, lateral, longitudinal, front, back, top, bottom, above, below, vertical, horizontal, radial, axial, clockwise, and counterclockwise) are only used for identification purposes to aid the reader's understanding of the example embodiments described herein, and are not limiting, particularly as to the position, orientation, or use of the inventive concepts unless specifically set forth in the claims. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other unless specifically stated.

In some instances, components are described with reference to “ends” having a particular characteristic and/or being connected with another part. However, those skilled in the art will recognize that the components described are not limited to components which terminate immediately beyond their points of connection with other parts. Thus, the term “end” should be interpreted broadly, in a manner that includes areas adjacent, rearward, forward of, or otherwise near the terminus of a particular element, link, component, part, member or the like. In methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. A furrow closing assembly for an agricultural planter, comprising
a mounting bracket configured for attachment to a furrow opener assembly of the agricultural planter;
a rigid frame configured for mounting furrow closing components thereon;
a parallel linkage pivotably connecting the mounting bracket to the rigid frame with a first pivot bearing connecting the mounting bracket to the parallel linkage and a second pivot bearing connecting the parallel linkage to the rigid frame; and
a screw-driven linear actuator fixed at a first end to the rigid frame and attached at a second end to the parallel linkage.

2. The furrow closing assembly of claim 1, wherein the screw driven linear actuator is pivotably attached to the parallel linkage.

3. The furrow closing assembly of claim 1, wherein
the parallel linkage comprises a four bar linkage;
two upper bars of the four bar linkage are both attached to the first pivot bearing at first ends and are both attached to the second pivot bearing at second ends; and
two lower bars of the four bar linkage are both attached to the mounting bracket at a third pivot bearing at first ends and are both attached to the rigid frame at a fourth pivot bearing at second ends.

4. The furrow closing assembly of claim 1, wherein
the two upper bars are positioned parallel to each other and are laterally separated from each other; and
the two lower bars are vertically separated from the two upper bars, are positioned parallel to each other, and are laterally separated from each other.

5. The furrow closing assembly of claim 2, further comprising a torsion axle fixed to the parallel linkage and wherein a shaft of the screw-driven linear actuator is pivotably attached to the torsion axle.

6. The furrow closing assembly of claim 5, wherein the torsion axle further comprises
an elongated block or tube of square cross section extending between and fixedly attached at each end to opposite bars of the parallel linkage;
a square tube of larger perimeter dimension than the elongated block or tube placed concentrically about the elongated block or tube; and
a plurality of dense elastomeric members positioned between exterior walls of the elongated block or tube and interior walls of the square tube.

7. The furrow closing assembly of claim 1, further comprising a load cell mounted between a first end of the linear actuator and the rigid frame.

8. A method of operating a furrow closer assembly comprising a parallel linkage attached between a furrow opener assembly and a frame of the furrow closer assembly and a screw drive linear actuator fixedly mounted to the frame and pivotably mounted to the parallel linkage, wherein the method comprises
actuating the linear actuator to extend a shaft of the linear actuator; and
providing a downward force on the furrow closer assembly by extension of the shaft.

9. The method of claim 8, further comprising translating the downward force to a furrow closing device attached to the frame of the furrow closer assembly.

10. The method of claim 8, further comprising
actuating the linear actuator to retract a shaft of the linear actuator; and
providing an upward force on the furrow closer assembly by retraction of the shaft.

11. The method of claim 9, further comprising lifting the furrow closer assembly above a field surface by provision of the upward force.

12. A furrow closing assembly for an agricultural planter, comprising
a mounting bracket configured for attachment to a furrow opener assembly of the agricultural planter;
a rigid frame configured for mounting furrow closing components thereon;
a parallel linkage pivotably connecting the mounting bracket to the rigid frame with a first pivot bearing connecting the mounting bracket to the parallel linkage and a second pivot bearing connecting the parallel linkage to the rigid frame;
a torsion axle fixed to the parallel linkage; and
an actuator fixed at a first end to the rigid frame and pivotally attached to the torsion axle.

13. The furrow closing assembly of claim 12, wherein the torsion axle is configured to allow travel between the actuator and the parallel linkage.

14. The furrow closing assembly of claim 13, wherein the travel is constrained by a plurality of torsion bumpers integrated with the torsion axle.

15. The furrow closing assembly of claim 14, wherein the plurality of torsion bumpers comprises a plurality of dense elastomeric members configured to compress with movement of the actuator relative to the parallel linkage.

16. The furrow closing assembly of claim 13, wherein
the torsion axle further comprises a torsion block fixedly attached to the parallel linkage, the plurality of torsion bumpers arranged about the torsion block, and
a case wrapped around the plurality of torsion bumpers and the torsion block.

17. The furrow closing assembly of claim 16, wherein
the torsion block further comprises a coupler plate extending from the case, and
the actuator is pivotally attached to the torsion axle at the coupler plate.

18. The furrow closing assembly of claim 17, wherein a shaft of the actuator is engaged in double shear with the coupler plate.

19. The furrow closing assembly of claim 12, wherein the actuator comprises a screw-driven linear actuator.

20. The furrow closing assembly of claim 17, wherein the screw-drive linear actuator comprises an electromechanical device with a screw drive, the screw-drive linear actuator being configured to provide static resistance to external forces received by the parallel linkage.
